(19) United States
(12) Patent Application Publication
(10) Pub. No.: US 2024/0405802 A1
(43) Pub. Date: Dec. 5, 2024

(54) DISPLAY APPARATUS AND ELECTRONIC DEVICE

(71) Applicants: Beijing BOE Optoelectronics Technology Co., Ltd., Beijing (CN); BOE Technology Group Co., Ltd., Beijing (CN)

(72) Inventors: Xiaojuan WU, Beijing (CN); Chunnan FENG, Beijing (CN); Jingjun DU, Beijing (CN); Yujie LIU, Beijing (CN); Jiaxing WANG, Beijing (CN); Yu ZHAO, Beijing (CN); Xian WANG, Beijing (CN); Jian WANG, Beijing (CN); Biqi LI, Beijing (CN); Feng QU, Beijing (CN)

(21) Appl. No.: 18/691,082

(22) PCT Filed: Dec. 16, 2021
(86) PCT No.: PCT/CN2021/138789

§ 371 Date: Mar. 12, 2024

(51) Int. Cl. H04B 5/26; G02F 1/1333

(52) U.S. Cl. CPC H04B 5/26; G02F 1/133314

(57) ABSTRACT

A display apparatus comprises a back housing (DD), a backlight module (BLU) and a display module (PNL), which are sequentially arranged in a stacked manner. The display apparatus has an NFC wiring area (CC) for an NFC coil (LL) to be arranged therein; the NFC coil (LL) is arranged on the display module (PNL); and a ferrite layer (FF), which overlaps with the NFC wiring area (CC), is arranged between the back housing (DD) and a rear housing (E1) of the backlight module (BLU), and/or the rear housing (E1) of the backlight module (BLU) is provided with an opening which overlaps with the NFC wiring area (CC), and/or at least part of the area in which the back housing (DD) and the rear housing (E1) of the backlight module (BLU) overlap with the NFC wiring area (CC) is made of a non-metallic material.

### CROSS REFERENCE

The present application is a national phase application of International Application No. PCT/CN2021/138789, filed on Dec. 16, 2021, and the entire contents thereof are incorporated herein by reference.

### TECHNICAL FIELD

The present disclosure relates to the field of display technology, and in particular, to a display device and electronic equipment.

### BACKGROUND

Compared with existing short-range wireless communication technologies such as non-contact radio frequency identification (RFID), Bluetooth, and infrared, NFC (near field communication) technology has extremely high security (transmission distance <10 cm), is both readable and writable, has low energy consumption and other advantages. Integrating the NFC coil into the display screen has the advantages of simple process, no increase in module thickness, and simple module structure.

It should be noted that, information disclosed in the above background portion is provided only for better understanding of the background of the present disclosure, and thus it may contain information that does not form the prior art known by those ordinary skilled in the art.

### SUMMARY

The present disclosure provides a display device and electronic equipment.

According to an aspect of the present disclosure, a display device is provided, including a back casing, a backlight module and a display module that are stacked in sequence; the display device has an NFC wiring area for disposing an NFC coil; and the NFC coil is disposed in the display module.

According to an embodiment of the present disclosure, a rear casing of the backlight module is made of metal material; the rear casing of the backlight module has an opening area overlapped with the NFC wiring area; and the rear casing of the backlight module is provided with an opening in the opening area.

According to an embodiment of the present disclosure, the rear casing of the backlight module is provided with one opening in the opening area; and an edge of the opening is coincided with an edge of the opening area.

According to an embodiment of the present disclosure, the rear casing of the backlight module is provided with a plurality of openings in the NFC wiring area.

According to an embodiment of the present disclosure, the NFC coil includes a body wiring disposed in a display area; and
the body wiring is arranged axially symmetrically; and the opening area is arranged symmetrically with respect to a symmetry axis of the body wiring.

According to an embodiment of the present disclosure, the NFC wiring area includes an NFC first wiring area disposed in a display area and an NFC second wiring area disposed in a peripheral area; and
at least part of the NFC first wiring area is covered by the opening area.

According to an embodiment of the present disclosure, the NFC wiring area includes an NFC first wiring area disposed in a display area and an NFC second wiring area disposed in a peripheral area; and
a geometric center of the opening area is coincided with a geometric center of the NFC first wiring area.

According to an embodiment of the present disclosure, the back casing is made of metal material; and the display device is provided with a ferrite layer between the back casing and the rear casing of the backlight module.

According to an embodiment of the present disclosure, the ferrite layer is disposed on a surface of the rear casing of the backlight module away from the display module.

According to an embodiment of the present disclosure, an orthographic projection of the ferrite layer on the display module is overlapped with the NFC wiring area.

According to an embodiment of the present disclosure, the NFC wiring area includes an NFC first wiring area disposed in a display area and an NFC second wiring area disposed in a peripheral area; and
at least part of the NFC first wiring area is covered by the ferrite layer.

According to an embodiment of the present disclosure, the NFC coil includes a body wiring disposed in a display area; and
the body wiring is covered by the ferrite layer.

According to an embodiment of the present disclosure, the NFC coil includes a body wiring disposed in a display area; and
the body wiring is arranged axially symmetrically; and the ferrite layer is arranged symmetrically with respect to a symmetry axis of the body wiring.

According to an embodiment of the present disclosure, the back casing is made of metal material; and the display device is provided with a ferrite layer between the back casing and the rear casing of the backlight module; and
at least part of the open area is covered by the ferrite layer.

According to an embodiment of the present disclosure, the opening area is covered by the ferrite layer.

According to an embodiment of the present disclosure, the back casing is made of non-metallic material.

According to an embodiment of the present disclosure, at least a part area of the back casing overlapped with the NFC wiring area is made of non-metallic material; and at least a part area of the rear casing of the backlight module overlapped with the NFC wiring area is made of non-metallic material.

According to an embodiment of the present disclosure, both the back casing and the rear casing of the backlight module are made of non-metallic materials.

According to another aspect of the present disclosure, an electronic equipment is provided, which includes the above display device.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. Obviously, the drawings in the following description are only some embodiments of the present disclosure. For those of ordinary skill in the art, other drawings can be obtained based on these drawings without exerting creative efforts.

FIG. 1 is a schematic structural diagram of a display device in an embodiment of the present disclosure; wherein, the back casing and the rear casing of the backlight module are made of non-metallic materials.

FIG. 2 is a schematic structural diagram of a display device in an embodiment of the present disclosure; wherein, the rear casing of the backlight module is made of non-metallic material, and the back casing is made of metal material.

FIG. 3 is a schematic structural diagram of a display device in an embodiment of the present disclosure; wherein, the back casing is made of non-metallic material, and the rear casing of the backlight module is made of metal material.

FIG. 4 is a schematic structural diagram of a display device in an embodiment of the present disclosure; wherein, the back casing and the rear casing of the backlight module are made of metal materials.

FIG. 5 is a schematic structural diagram of a backlight module in an embodiment of the present disclosure.

FIG. 6 is a schematic top structural view of a display device in an embodiment of the present disclosure.

FIG. 7 is a schematic top structural view of an NFC coil in an embodiment of the present disclosure.

FIG. 8 is a schematic structural diagram of the wiring body in an embodiment of the present disclosure.

FIG. 9 is a schematic structural diagram of the wiring body in an embodiment of the present disclosure.

FIG. 10 is a schematic structural diagram of the wiring body and the ferrite layer in an embodiment of the present disclosure.

FIG. 11 is a schematic structural diagram of the wiring body and the ferrite layer in an embodiment of the present disclosure.

FIG. 12 is a schematic structural diagram of the wiring body and the ferrite layer in an embodiment of the present disclosure.

FIG. 13 is a schematic structural diagram of the relative positional relationship between the wiring body and the opening area in an embodiment of the present disclosure.

FIG. 14 is a schematic structural diagram of the relative positional relationship between the wiring body and the opening area in an embodiment of the present disclosure.

FIG. 15 is a schematic structural diagram of the relative positional relationship between the wiring body and the opening area in an embodiment of the present disclosure.

FIG. 16 is a schematic structural diagram of the relative positional relationship between the wiring body and the opening area in an embodiment of the present disclosure.

FIG. 17 is a schematic structural diagram of the relative positional relationship between the wiring body and the opening area in an embodiment of the present disclosure.

FIG. 18 is a schematic structural diagram of the relative positional relationship between the wiring body and the opening area in an embodiment of the present disclosure.

FIG. 19 is a schematic structural diagram of the relative positional relationship between the wiring body, the ferrite layer and the opening area in an embodiment of the present disclosure.

FIG. 20 is a schematic structural diagram of the relative positional relationship between the wiring body, the ferrite layer and the opening area in an embodiment of the present disclosure.

FIG. 21 is a schematic structural diagram of the relative positional relationship between the wiring body, the ferrite layer and the opening area in an embodiment of the present disclosure.

FIG. 22 is a schematic structural diagram of the relative positional relationship between the wiring body, the ferrite layer and the opening area in an embodiment of the present disclosure.

FIG. 23 is a schematic structural diagram of the relative positional relationship between the wiring body, the ferrite layer and the opening area in an embodiment of the present disclosure.

FIG. 24 is a schematic structural diagram of the relative positional relationship between the wiring body, the ferrite layer and the opening area in an embodiment of the present disclosure.

FIG. 25 is a schematic structural diagram of the relative positional relationship between the wiring body, the ferrite layer and the opening area in an embodiment of the present disclosure.

FIG. 26 is a schematic structural diagram of the rear casing of the backlight module in an embodiment of the present disclosure.

FIG. 27 is a schematic structural diagram of the rear casing of the backlight module in an embodiment of the present disclosure.

FIG. 28 is a schematic structural diagram of the rear casing of the backlight module in an embodiment of the present disclosure.

FIG. 29 is a schematic structural diagram of the rear casing of the backlight module in an embodiment of the present disclosure.

FIG. 30 is a schematic structural diagram of the rear casing of the backlight module in an embodiment of the present disclosure.

FIG. 31 is a schematic structural diagram of the rear casing of the backlight module in an embodiment of the present disclosure.

FIG. 32 is a schematic structural diagram of the relative positional relationship between the wiring body and the opening area in an embodiment of the present disclosure.

### DETAILED DESCRIPTION

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete and will fully convey the concepts of the example embodiments to those skilled in the art. The same reference numerals in the drawings represent the same or similar structures, and thus their detailed descriptions will be omitted. Furthermore, the drawings are merely schematic illustrations of the present disclosure and are not necessarily drawn to scale.

Although relative terms, such as “upper” and “lower” are used in this specification to describe the relative relationship of one component illustrated in the drawings to another component, these terms are used in this specification only for convenience, for example, according to the direction of the example described drawings. It will be understood that if the illustrated device were turned upside down, components described as “upper” would become “lower” components. When a structure is “on” another structure, it may mean that the structure is integrally formed on the other structure, or that the structure is “directly” placed on the other structure, or that the structure is “indirectly” placed on the other structure through another structure.

The terms “a”, “an”, “the”, “said” and “at least one” are used to indicate the presence of one or more elements/components/etc.; the terms “include” and “have” are used to indicate an open-ended inclusive and mean that there may be additional elements/components/etc. in addition to those listed; and the terms “first”, “second”, “third” etc. are only used as a marker, not a limit on the number of its objects.

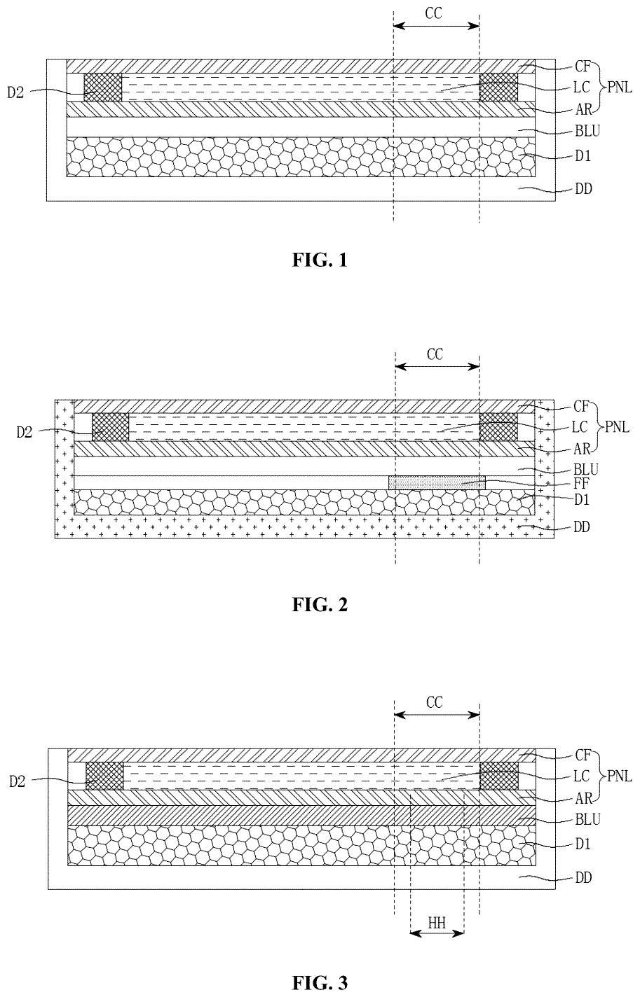

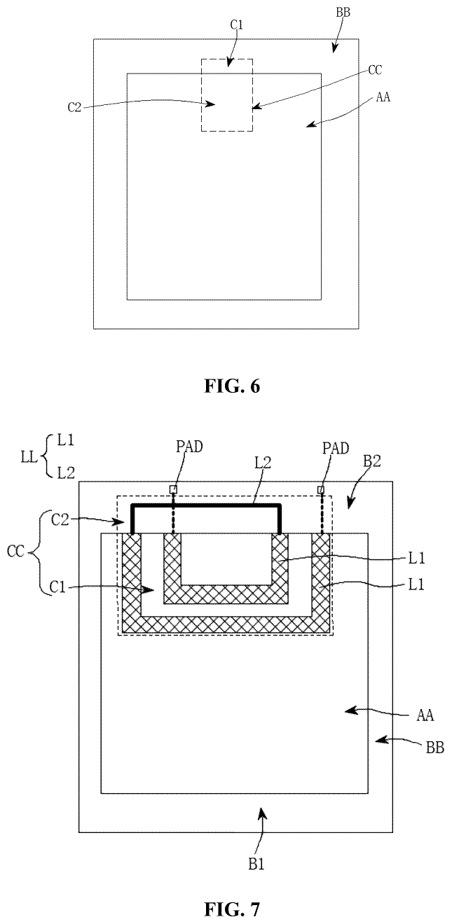

The present disclosure provides a display device and electronic equipment having the display device. Referring to FIGS. 1 to 4, the display device includes a back casing DD, a backlight module BLU and a display module PNL which are stacked in sequence. From a top view, see FIG. 6, the display device has an NFC wiring area CC for disposing the NFC coil LL; and the display module PNL is disposed with the NFC coil LL in the NFC wiring area CC for near field communication.

The display device of the present disclosure can use one or more of the following means to improve the intensity, area, and distance of near field communication: disposing a ferrite layer FF overlapped with the NFC wiring area CC between the back casing DD and the rear casing of the backlight module BLU; having an opening H1 overlapped with the NFC wiring area CC in the rear casing E1 of the backlight module BLU; using non-metallic materials for at least part area of the rear casing E1 of the backlight module BLU and the back casing DD overlapped with the NFC wiring area CC. In this way, the influence of the back casing DD and the rear casing E1 of the backlight module BLU on the signal magnetic field of near field communication can be overcome, and the intensity of the signal magnetic field can be increased, thus ensuring the smooth implementation of near field communication.

In this disclosure, when describing the overlap between structure A (such as film layer, wiring, or openings, etc.) and structure B (such as film layer, wiring, or openings, etc.), it means that the orthographic projection of structure A on the display module has an overlapped area with the orthographic projection of the structure B on the display module. When describing the partial overlap between structure A (such as film layers, wiring, or openings, etc.) and structure B (such as film layers, wiring, or openings, etc.), it means that the orthographic projection of structure A on the display module has an overlapped area with the orthographic projection of the structure B on the display module, and also has a not overlapped. When describing structure A (such as film layer, wiring or openings, etc.) covering structure B (such as film layer, wiring or openings, etc.), it means that the orthographic projection of structure B on the display module is within the orthographic projection of structure A on the display module. When describing that structure A (such as film layers, wiring, or openings, etc.) is coincide with structure B (such as film layers, wiring, or openings, etc.), it means that the orthographic projection of structure A on the display module is completely overlapped with the orthographic projections of structure B on the display module.

Hereinafter, the structure, principle and effect of the display device of the present disclosure will be further explained and described with reference to the accompanying drawings.

Referring to FIGS. 1 to 4, the display module PNL may be a liquid crystal display module PNL, which may include an array substrate AR, a liquid crystal layer LC and a color filter substrate CF aligned into an LC cell. In the embodiment, the array substrate AR can be provided with array-distributed pixel electrodes and a pixel drive circuit that drives the pixel electrodes; the color filter substrate CF is provided with a stacked black matrix layer and a color filter layer, and each color filter on the color filter layer can be disposed in one-to-one correspondence with the pixel electrode. A sealing adhesive layer D2 is also provided between the array substrate AR and the color filter substrate CF. The sealing adhesive layer D2 is provided around the liquid crystal layer LC to form a liquid crystal cell and connect the array substrate AR and the color filter substrate CF. Further, the display module PNL may further include a first polarizer located on the side of the array substrate AR away from the color filter substrate CF and a second polarizer located on the side of the color filter substrate CF away from the display module PNL.

In some embodiments of the present disclosure, the array substrate AR includes a base substrate and a driving circuit layer provided on one side of the base substrate. The driving circuit layer is provided with a pixel driving circuit and a pixel electrode. In one example, the driving circuit layer includes a plurality of gate lines extending along the row direction and a plurality of data lines extending along the column direction. Gate lines and data lines are intersected to define multiple pixel areas. Each pixel area is provided with a thin film transistor and a pixel electrode as a pixel driving circuit. The source of the thin film transistor is electrically connected to the adjacent data line, the gate electrode of the thin film transistor is electrically connected to the adjacent gate line, and the drain electrode of the thin film transistor is electrically connected to the pixel electrode in the same pixel area.

The display module PNL may also have a common electrode for loading a common voltage. The common electrode may be provided on the color filter substrate CF or on the driving layer. This disclosure does not limit this.

Referring to FIGS. 6 and 7, along the top view direction, the display module PNL includes a display area AA for display and a peripheral area BB surrounding the display area AA. In the embodiment, the pixel driving circuit and the pixel electrode are located in the display area AA. In the peripheral area BB, a first sub-peripheral area B1 may be provided, and the first sub-peripheral area B1 is provided with a pad for electrical connection with the control circuit of the display device.

In the present disclosure, an NFC wiring area CC may be provided in the display module PNL, and an NFC coil LL may be provided in the NFC wiring area CC. In the embodiment, the NFC wiring area CC includes the area occupied by the wiring of the NFC coil LL and the area surrounded by these wirings.

The NFC coil LL can be disposed on the array substrate AR or on the color filter substrate CF, which is not limited in this disclosure. In an embodiment of the present disclosure, the NFC wiring area CC is provided on the array substrate AR and is provided on the same layer as the pixel driving circuit. For example, the wiring in the NFC wiring area CC can be provided on the gate layer, the source and drain metal layers, or across the two layers. In another embodiment of the present disclosure, the NFC wiring area CC is provided on the color filter substrate CF. For example, a wiring layer can be provided on the side of the black matrix layer close to the array substrate AR, and the NFC coil LL is formed in the wiring layer. In the embodiment, at least part of the NFC coil LL can be shielded under the black matrix layer. In an embodiment of the present disclosure, the orthographic projection of at least part of the wiring of the NFC coil LL on the black matrix layer may be located within the black matrix layer.

In one embodiment of the present disclosure, referring to FIG. 7, the peripheral area BB includes a second sub-peripheral area B2 opposite to the first sub-peripheral area B1, and the second sub-peripheral area B2 and the first sub-peripheral area B1 are respectively located at two sides of the display area AA. Two pads PAD respectively used for electrical connection with both ends of the NFC coil LL may be provided in the second sub-peripheral area B2. The two pads PAD are electrically connected to both ends of the NFC coil LL through wiring.

In one embodiment of the present disclosure, the NFC coil LL has one turn of wiring. Referring to FIG. 9, the NFC coil LL includes a body wiring L1 located in the display area AA. Both ends of the body wiring L1 are electrically connected to the two PADs through wirings.

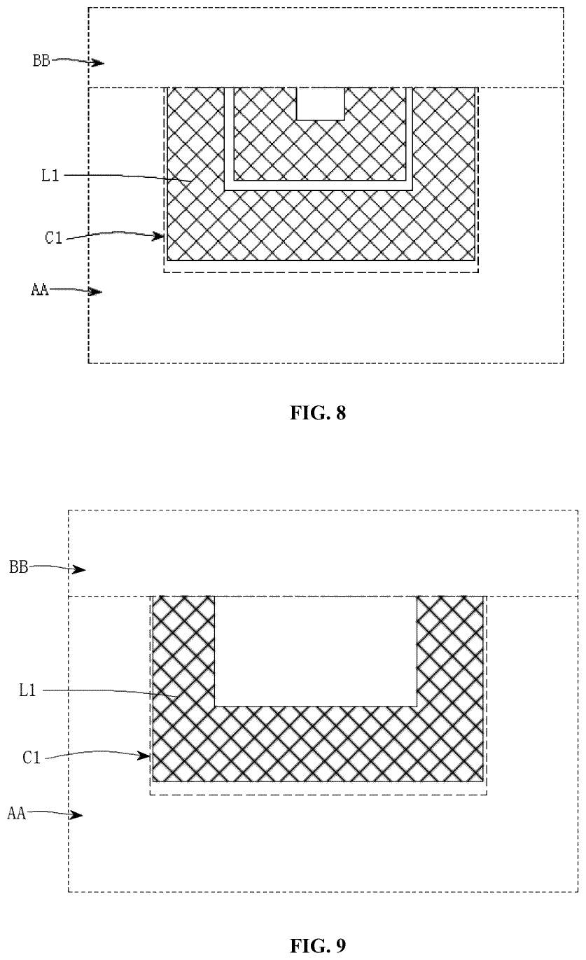

In another embodiment of the present disclosure, the NFC coil LL has multiple turns of wiring. The NFC coil LL includes a plurality of body wirings L1 located in the display area AA and at least one connection wiring L2 located in the peripheral area BB. The body wirings L1 are connected in series through the connection wiring L2 to form a complete NFC coil LL. In the embodiment, both ends of the NFC coil LL are electrically connected to the pad PAD through wires respectively. For example, referring to FIG. 8, the NFC coil LL includes two turns of wirings; and the NFC coil LL includes two body wirings L1 in the display area AA.

In some embodiments of the present disclosure, referring to FIG. 7, the NFC wiring area CC includes an NFC first wiring area C1 located in the display area AA and an NFC second wiring area C2 located in the peripheral area BB. The NFC first wiring area C1 is the wiring range of the body wiring L1, and the NFC second wiring area C2 is the wiring range of the connection wiring L2.

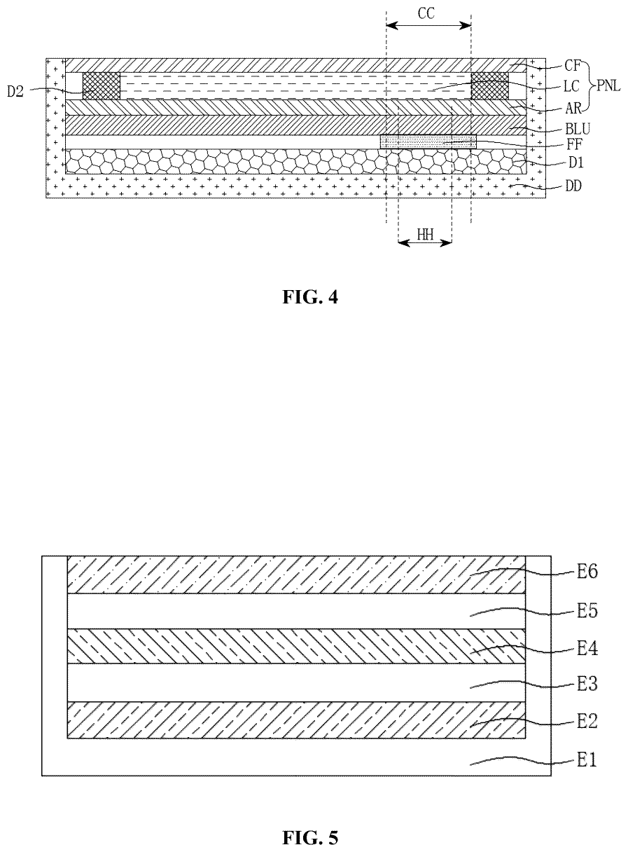

In an embodiment of the present disclosure, referring to FIG. 5, the backlight module BLU may include a rear casing E1 and a light source E3 that are stacked in sequence. The light source E3 may be a side-type light source E3 or a direct-type light source E3. For example, in one example, the light source E3 includes a light guide plate and a light-emitting element facing the side of the light guide plate. The light emitted by the light-emitting element is uniformly emitted through the light guide plate.

Further, the backlight module BLU may also include a reflective layer E2 sandwiched between the light source E3 and the back case E1, and include a diffusion sheet E4, a lower prism film E5, a upper prism film E6, etc., that are laminated in sequence on the side of the light source E3 away from the back casing DD.

Optionally, in some embodiments, the display device is further provided with an accommodating cavity between the back casing DD and the backlight module BLU, and the accommodating cavity is used to arrange components such as the control circuit D1 of the display device. In an embodiment of the present disclosure, the display device may further be provided with a battery in the accommodation cavity.

During product testing, the inventor found that the back casing DD and the rear casing E1 of the backlight module BLU have a great impact on the communication distance of the NFC coil LL. To this end, the present disclosure proposes a targeted solution to ensure that when the NFC coil LL is disposed at the display module PNL, the display device still has an appropriate near field communication distance and communication area, ensuring the near field communication function of the display device.

In some embodiments of the present disclosure, at least part of the area where the back casing DD of the display device overlaps with the NFC wiring area CC can be made of non-metallic material, and at least part of the area where the rear casing E1 overlaps with the NFC wiring area CC can be made of non-metallic material. In other words, the back casing DD has a first area made of a non-metallic material, and the rear casing E1 has a second area made of a non-metallic material. The first area at least partially overlaps the NFC wiring area CC, for example, it is completely located within the NFC wiring area CC or completely covers the NFC wiring area CC; and the second area at least partially overlaps the NFC wiring area CC, for example, it is completely located within the NFC wiring area CC or completely covers the NFC wiring area CC. Since non-metallic materials will not interfere with the magnetic field of the NFC wiring area CC, the first area and the second area can serve as signal channels for the NFC wiring area CC to ensure the communication distance.

As an example, see FIG. 1, both the back casing DD of the display device and the rear casing E1 of the backlight module BLU can be made of non-metallic materials, such as plastic materials, to avoid the impact of the back casing DD and the rear casing E1 on the NFC wiring area CC. In this way, the rear casing E1 and the back casing DD will not interfere with the magnetic field of the NFC wiring area CC, thereby enabling the display device to have a sufficient near field communication distance to ensure its near field communication function. The material of the back casing DD and the rear casing E1 may be the same or different, and this disclosure does not limit this.

In some embodiments of the present disclosure, see FIGS. 2 and 4, the back casing DD is made of metal material; the display device is provided with a ferrite layer FF between the back casing DD and the rear casing E1 of the backlight module BLU. In the embodiment, the ferrite layer FF and the NFC wiring area CC at least partially overlap. In this way, the ferrite layer FF can reduce the absorption of the signal magnetic field by the metal material on the back casing DD. Further, the ferrite layer FF can also increase the intensity of the signal magnetic field. In this way, by providing the ferrite layer FF, the intensity of the signal magnetic field can be effectively ensured, thereby ensuring or increasing the sensing distance of the NFC wiring area CC. In this embodiment, the material of the rear casing E1 can be a metal material or a non-metal material, and the ferrite layer FF can effectively reduce the influence of the back casing DD on the signal magnetic field.

In one embodiment of the present disclosure, see FIG. 2, the back casing DD is made of metal material, and the rear casing E1 is made of non-metal material. In this way, the rear casing E1 has no effect on the intensity of the signal magnetic field. By providing the ferrite layer FF to overcome the influence of the back casing DD on the signal magnetic field, the near field communication function of the display device can be ensured.

In an embodiment of the present disclosure, the ferrite layer FF may be made of high-temperature sintered ferrite material.

In one embodiment of the present disclosure, the ferrite layer FF is attached to the surface of the rear casing E1 away from the display module PNL, so as to be as close as possible to the rear casing E1 to enhance the intensity of the signal magnetic field and reduce the absorption of the magnetic field by the back casing DD.

In some embodiments of the present disclosure, the orthographic projection of the ferrite layer FF on the display module PNL can cover at least part of the NFC wiring area CC, for example, it can cover the NFC first wiring area C1 or cover each body wiring. L1, or completely cover the NFC wiring area CC. The shape of the ferrite layer FF can be determined according to requirements, for example, it can be a rectangular, U-shaped, annular, and other shapes.

In an embodiment of the present disclosure, the body wiring L1 is arranged axially symmetrically; and the ferrite layer FF is arranged symmetrically with respect to the symmetry axis of the body wiring L1.

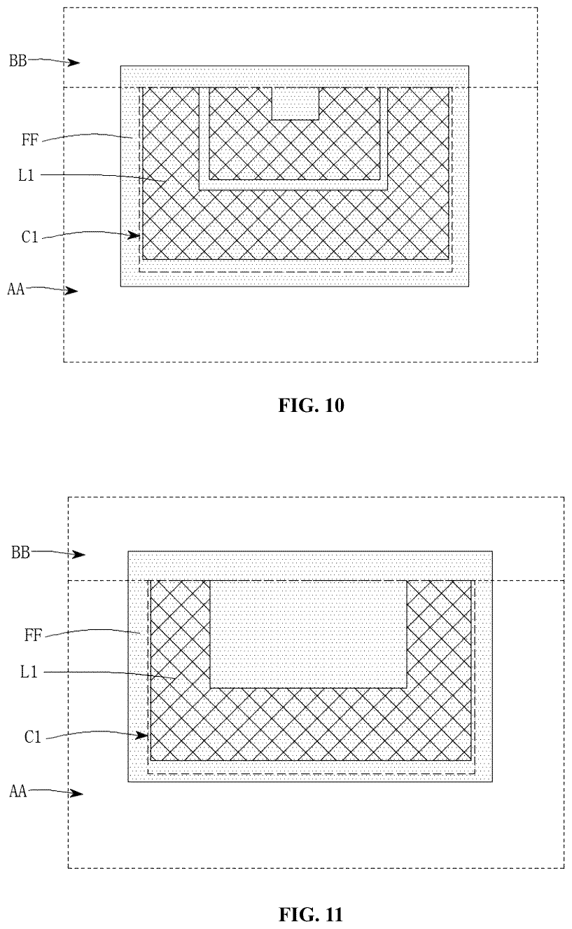

In one example, referring to FIG. 10, the NFC coil LL includes two body wirings L1; the ferrite layer FF is rectangular, and the orthographic projection of the ferrite layer FF on the display module PNL covers each body wiring L1. Further, referring to FIG. 10, the orthographic projection of the ferrite layer FF on the display module PNL can also be extended into the peripheral area BB.

In another example, referring to FIG. 11, the NFC coil LL includes a body wiring L1; the ferrite layer FF is rectangular, and the orthographic projection of the ferrite layer FF on the display module PNL covers the body wiring L1. Further, referring to FIG. 11, the orthographic projection of the ferrite layer FF on the display module PNL can also be extended into the peripheral area BB.

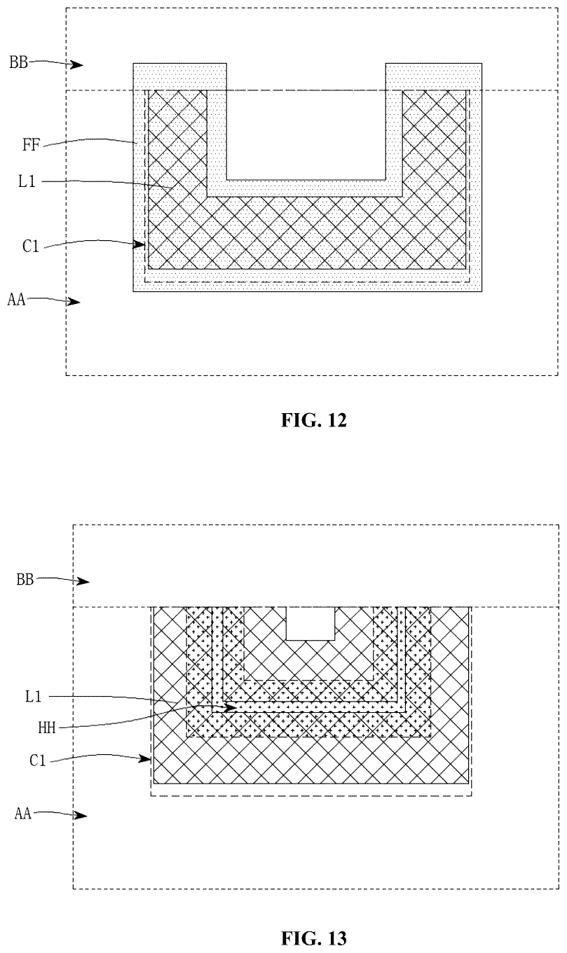

In another example, referring to FIG. 12, the NFC coil LL includes a body wiring L1. The main body wiring L1 is U-shaped and includes three sections of sub-wiring connected in sequence. The ferrite layer FF is U-shaped, and includes three sub-structures connected in sequence; the three sections of sub-wiring of the body wiring L1 and the three sections of sub-structure of the ferrite layer FF are arranged in one-to-one correspondence; each sub-wiring is covered by the corresponding sub-structure. In other words, the orthographic projection of the sub-structure on the display module PNL can cover the corresponding sub-wiring. In an embodiment of the present disclosure, the width of the sub-structure is greater than the width of the corresponding sub-wiring; the extension central axis of the sub-structure coincides with the extension central axis of the sub-wiring. In this way, the shape of the ferrite layer FF is substantially consistent with the shape of the body wiring L1 and is larger than the size of the body wiring L1, so that the orthographic projection of the ferrite layer FF on the display module PNL covers the body wiring L1. Further, referring to FIG. 12, the orthographic projection of the ferrite layer FF on the display module PNL can also be extended into the peripheral area BB. Referring to FIG. 12, in this example, the ferrite layer FF may overlap a partial area of the NFC wiring area CC without covering the entire NFC wiring area CC.

It can be understood that in FIGS. 10 to 12, the orthographic projection of the ferrite layer FF on the display module PNL covering the body wiring L1 is taken as an example. However, in other embodiments of the present disclosure, the orthographic projection of the ferrite layer FF on the display module PNL may partially overlap or not overlap at all with the body wiring L1, so that the ferrite layer FF is overlapped with at least part area of the NFC wiring area.

In some embodiments of the present disclosure, referring to FIGS. 3 and 4, the rear casing E1 is made of metal material. At this time, the rear casing E1 may be provided with an opening area HH, and the opening area HH is provided with an opening H1, and the opening H1 at least partially overlaps with the NFC wiring area CC. In this way, the signal magnetic field can pass through the rear casing E1 through the opening H1, avoiding or weakening the shielding of the rear casing E1, and ensuring the strength of the signal magnetic field. In this embodiment, regardless of whether the back casing DD is made of metal or non-metal material, the opening H1 can weaken the influence of the rear casing E1 on the signal magnetic field, thereby improving the communication distance.

In an embodiment of the present disclosure, referring to FIG. 3, the rear casing E1 is made of metal material, and the back casing DD is made of non-metallic material. In this way, the back casing DD has no effect on the intensity of the signal magnetic field. The display device can ensure the communication function of the display device by providing the opening H1 on the rear casing E1 to weaken the influence of the back case E1.

In this embodiment, the rear case E1 has an opening area HH for arranging the opening H1, and the opening H1 is arranged in the opening area HH. In the opening area HH, one opening H1 can be arranged, or multiple openings H1 can be arranged, whichever can meet the requirements of near field communication. The opening area HH at least partially overlaps the NFC wiring area CC. It can either exceed the NFC wiring area CC or be within the NFC wiring area CC. It can either partially overlap the NFC coil LL or completely not overlap the NFC coil LL, subject to meeting the needs of near field communication.

In an embodiment of the present disclosure, the opening area HH covers at least part of the NFC first wiring area C1.

In one embodiment of the present disclosure, the geometric center of the opening area HH coincides with the geometric center of the NFC first wiring area C1.

In one embodiment of the present disclosure, both the opening area HH and the body wiring L1 have a symmetrical structure; the symmetry axis of the opening area HH coincides with the symmetry axis of the body wiring L1.

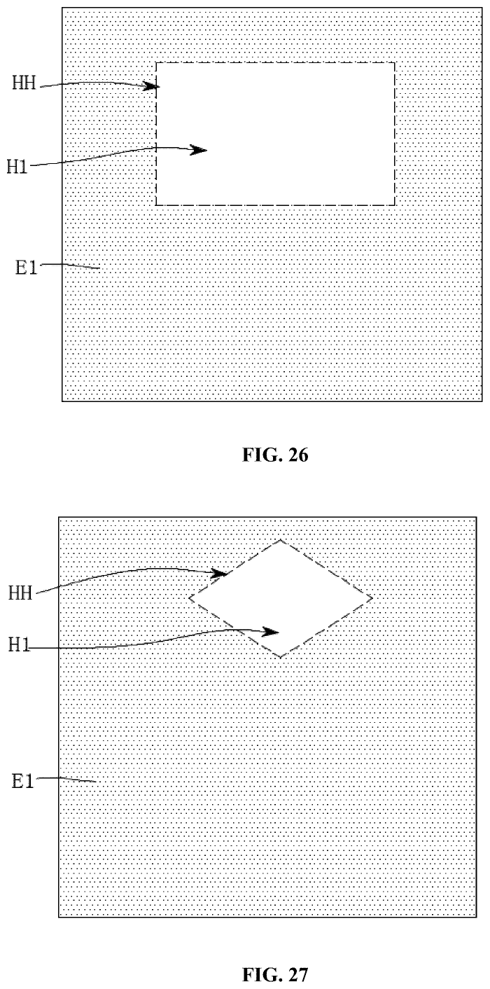

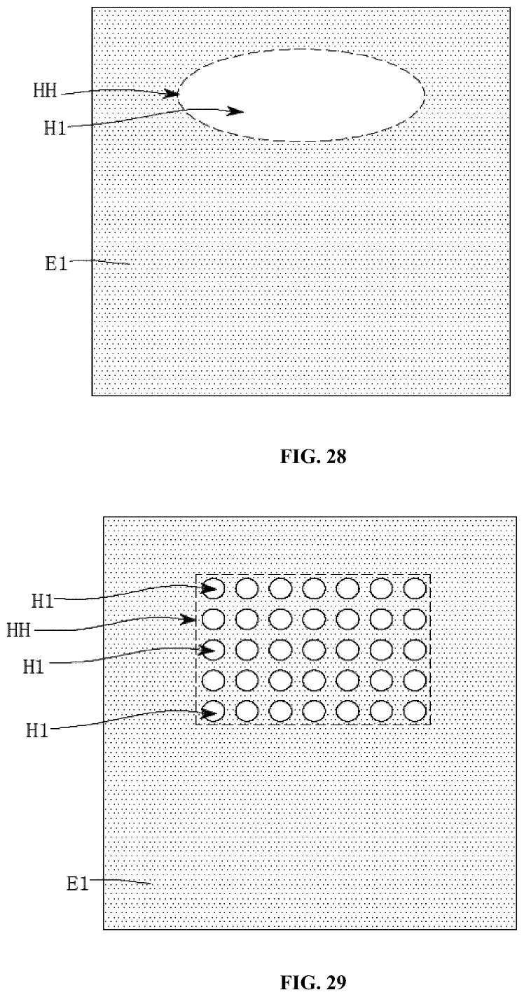

The shape of the opening area HH can be determined as needed, and can be rectangular (for example, as shown in FIG. 26), rhombus (for example, as shown in FIG. 27), oval (as shown in FIG. 28), circle, U-shaped, or S-shaped, arc, pentagon, hexagon or other shapes, this disclosure does not impose special limitations on this.

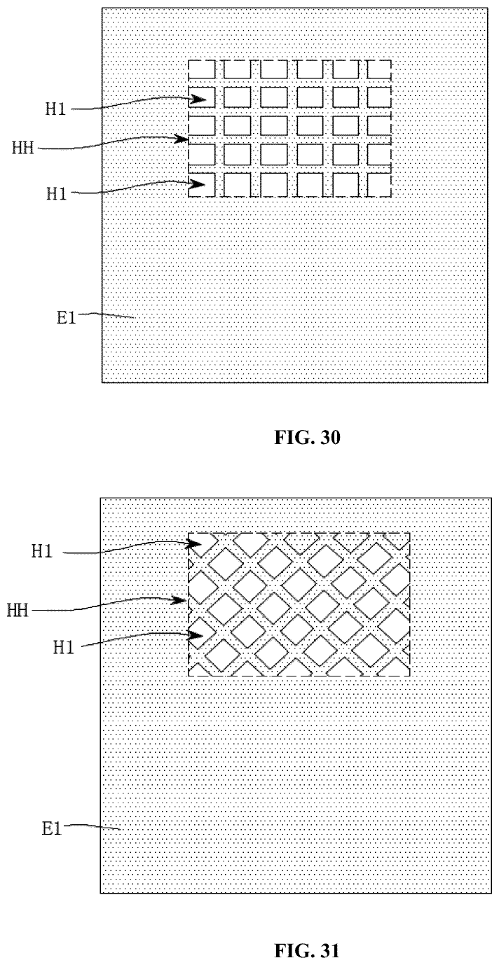

In the opening area HH, one opening H1 or multiple openings H1 can be arranged. For example, in one embodiment of the present disclosure, referring to FIGS. 26 to 28, an opening H1 is provided in the opening area HH, and the edge of the opening H1 is coincided with the edge of the opening area HH. In another embodiment of the present disclosure, referring to FIGS. 29 to 31, a plurality of openings H1 are provided in the opening area HH, so that the rear casing E1 is in a hollow state in the opening area HH. The opening H1 can be a rectangle (for example, as shown in FIGS. 30 and 31), a rhombus, an ellipse, a circle (as shown in FIG. 29), a U-shape, a star, a pentagon, a hexagon or other shapes, which is not limited in this disclosure. The respective opening H1 in the opening area HH can be distributed in an array, for example, along the row and column directions (as shown in FIGS. 29 and 30) or along the diagonal direction (as shown in FIG. 31). Of course, the respective opening H1 in the opening area HH may not be distributed in an array, for example, distributed along an arc-shaped trajectory or distributed randomly.

In one example, referring to FIG. 13, the NFC coil LL includes two body wirings L1; the body wiring L1 is U-shaped. The opening area HH is U-shaped, and the opening area HH covers the gap between the two body wirings L1 and covers the parts of the two body wirings L1 close to the gap. In other words, in this example, the opening area HH covers a part of each body wiring L1 and covers the gap between each body wiring L1. Further, the symmetry axis of the opening area HH coincides with the symmetry axis of the body wiring L1.

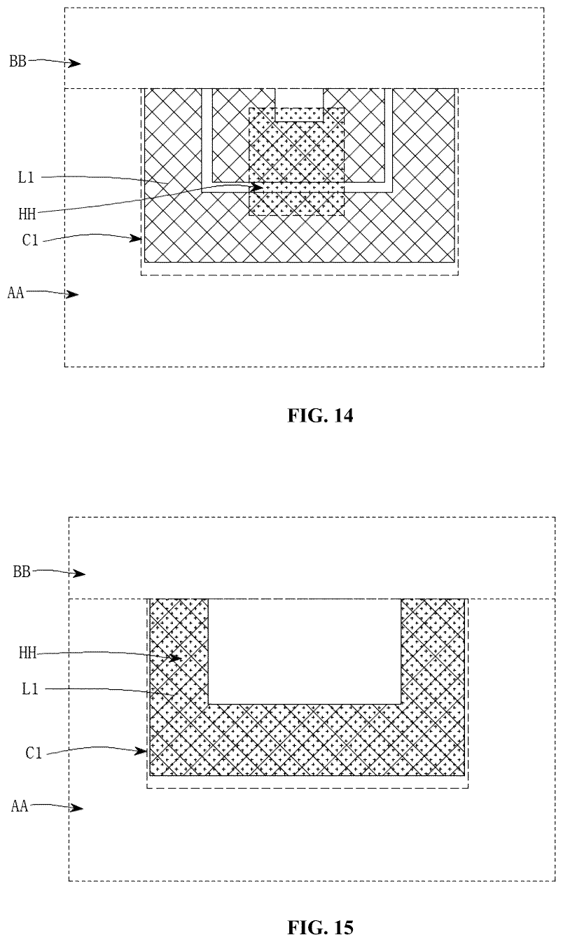

In another example, see FIG. 14, the NFC coil LL includes two body wirings L1; the body wiring L1 is U-shaped; the opening area HH is rectangular, and the opening area HH covers a part of the respective body wiring L1, and part of the gap between the body wirings L1. Further, the geometric center of the opening area HH is the same as the geometric center of the NFC first wiring area C1.

In another example, referring to FIG. 15, the NFC coil LL includes one body wiring L1; and the body wiring L1 is U-shaped. The opening area HH is U-shaped and coincides with the body wiring L1. That is, the orthographic projection of the opening area HH on the display module coincides with the body wiring L1. Further, the symmetry axis of the opening area HH coincides with the symmetry axis of the body wiring L1.

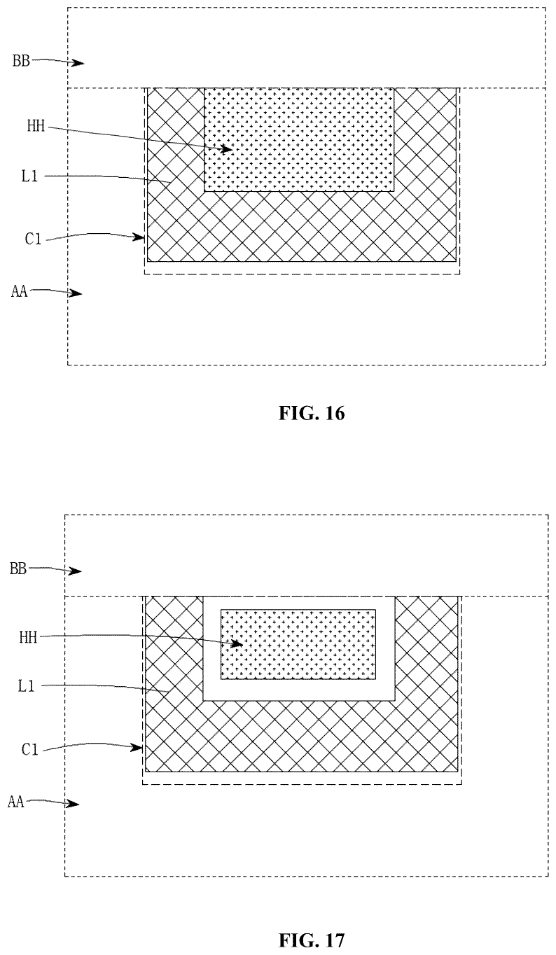

In another example, referring to FIG. 16, the NFC coil LL includes one body wiring L1; and the body wiring L1 is U-shaped. The opening area HH is rectangular and is located in the notch surrounded by the body wiring L1. In the embodiment, at least part of the edge of the opening area HH is flush with the edge of the body wiring L1 (the orthographic projections thereof on the display module PNL are coincided). Further, the symmetry axis of the opening area HH coincides with the symmetry axis of the body wiring L1.

In another example, referring to FIG. 17, the NFC coil LL includes one body wiring L1; and the body wiring L1 is U-shaped. The opening area HH is rectangular and is completely located in the notch surrounded by the body wiring L1. There is a gap between the orthographic projection of the opening area HH on the display module PNL and the edge of the body wiring L1. Further, the symmetry axis of the opening area HH coincides with the symmetry axis of the body wiring L1. Further, the geometric center of the opening area HH coincides with the geometric center of the notch surrounded by the body wiring L1.

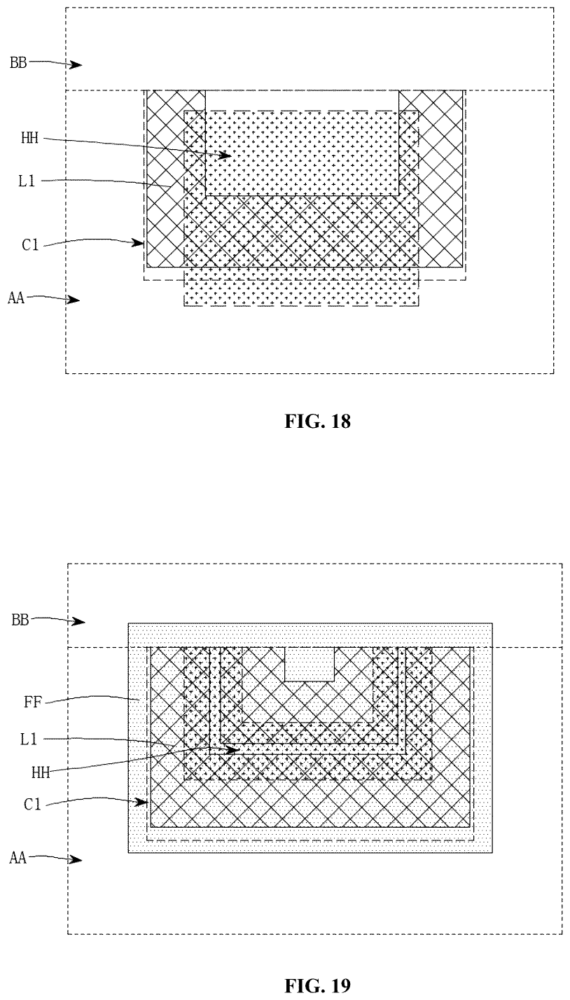

In another example, referring to FIG. 18, the NFC coil LL includes one body wiring L1; and the body wiring L1 is U-shaped. The opening area HH is rectangular. The opening area HH covers part of the body wiring L1, covers at least part of the notch surrounded by the body wiring L1, and at least partially extends out of the NFC wiring area CC. Further, the symmetry axis of the opening area HH coincides with the symmetry axis of the body wiring L1.

It can be understood that differences in the size, shape, and position of the opening area HH, as well as the differences in the pattern of the opening H1 in the opening area HH, will have an impact on the intensity of the signal magnetic field; however, these effects only enhance the intensity of the signal magnetic field. The optimal layout of the opening area HH and the opening H1 can be determined or selected through simulation.

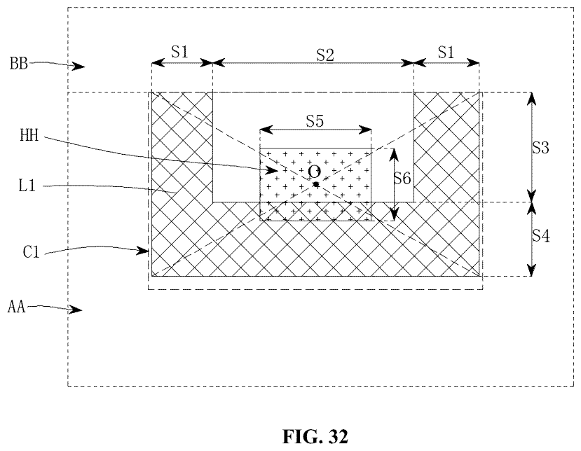

Take the relative relationship between the opening area HH and the NFC first wiring area C1 shown in FIG. 32 as an example; in this example, the NFC coil LL includes a body wiring L1, and the body wiring L1 is U-shaped, including three sub-wirings connected in sequence. The lengths of the three connected sub-wirings are S3, (S1+S2+S1), and S3; and the widths of the three sub-wirings are S1, S4, and S1. In the embodiment, S1 is 1.25 cm; S2 is 3.9 cm; S3 is 1.9 cm; and S4 is 1.5 cm. Taking the geometric center O of the body wiring L1 as the center, the rear casing E1 is provided with rectangular openings H1 of different sizes (the edge of the opening H1 is the edge of the opening area HH); and the geometric center of the opening H1 is O. In the embodiment, the length of the opening H1 is S5 and the width is S6; and the length direction of the opening H1 is parallel to the edge of the adjacent display area AA.

Different openings H1 are tested and the results are shown in the table below:

TABLE 1
Impact of different openings H1 on communication
distance and communication area

| H5*H6 | Communication distance | Communication area |
|---|---|---|
| 2 cm*1 cm | 1 cm | 15 cm² |
| 4 cm*2 cm | 3 cm | 27.5 cm² |
| 6 cm*3 cm | 4 cm | 12 cm² |

It can be known from Table 1 that the larger the area of the opening area HH is, the larger the communication distance is, while the communication area may become larger or smaller. In a specific display device, the area and shape of the opening area HH can be determined based on the communication distance and communication area requirements of the display device.

In some embodiments of the present disclosure, referring to FIG. 4, both the rear casing E1 and the back casing DD may be made of metal materials. It can be understood that the material of the rear casing E1 and the back casing DD may be the same or different. At this time, the rear casing E1 may be provided with an opening H1, and the opening H1 at least partially overlaps with the NFC wiring area CC to reduce the influence of the rear casing E1 on the signal magnetic field. A ferrite layer FF may be provided between the back casing DD and the back case E1, and the ferrite layer FF at least partially overlaps the NFC wiring area CC to weaken the influence of the back casing DD on the signal magnetic field or even enhance the signal magnetic field. In this way, even if the rear casing E1 and the back casing DD are both made of metal materials, the display device of the present disclosure can still have better signal magnetic field strength and better communication distance, which can ensure the near field communication function of the display device.

In one embodiment of the present disclosure, the ferrite layer FF covers at least part of the opening area HH, for example, completely covers the opening area HH.

In one embodiment of the present disclosure, the ferrite layer FF covers the opening area HH and covers the NFC first wiring area C1.

In one example, referring to FIG. 19, the NFC coil LL includes two body wirings L1; the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is U-shaped, and the opening area HH covers the gap between the two body wirings L1, and covers the parts of the two body wirings L1 close to the gap respectively; the symmetry axis of the opening area HH and the symmetry axis of the body wirings are coincided.

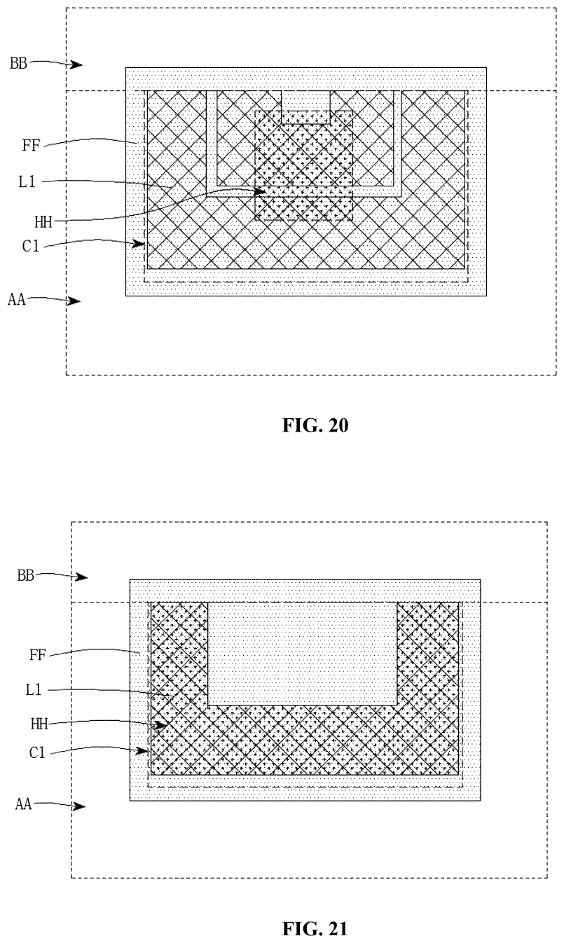

In another example, referring to FIG. 20, the NFC coil LL includes two body wirings L1; the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is rectangular, and the opening area HH covers a part of each body wiring L1 and a part of the gap between the body wirings L1. Further, the geometric center of the opening area HH is the same as the geometric center of the NFC first wiring area C1.

In another example, referring to FIG. 21, the NFC coil LL includes one body wiring L1; and the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is U-shaped and coincides with the body wiring L1. That is, the orthographic projection of the opening area HH on the display module PNL coincides with the body wiring L1. Further, the symmetry axis of the opening area HH coincides with the symmetry axis of the body wiring L1.

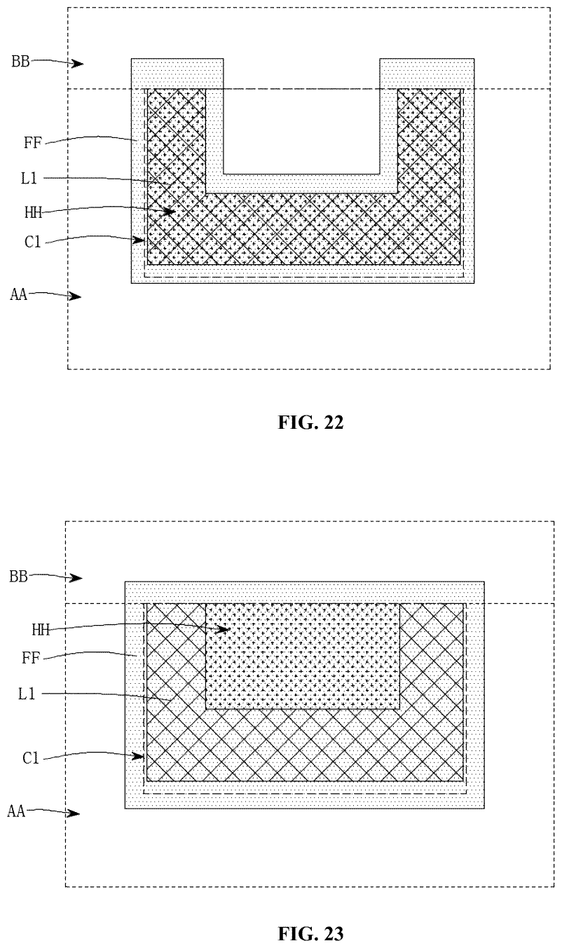

In another example, referring to FIG. 22, the NFC coil LL includes a body wiring L1. The main body wiring L1 is U-shaped and includes three sections of sub-wiring connected in sequence. The ferrite layer FF is U-shaped, and includes three sections of sub-structures connected in sequence; the three sections of sub-wiring of the body wiring L1 and the three sections of sub-structure of the ferrite layer FF are arranged in one-to-one correspondence; each sub-wiring is covered by the corresponding sub-structure. In other words, the orthographic projection of the sub-structure on the display module PNL can cover the corresponding sub-wiring. In an embodiment of the present disclosure, the width of the sub-structure is greater than the width of the corresponding sub-wiring; the extension central axis of the sub-structure coincides with the extension central axis of the sub-wiring. Further, referring to FIG. 22, the orthographic projection of the ferrite layer FF on the display module PNL can also extend into the peripheral area BB. The opening area HH is U-shaped and coincides with the body wiring L1. Further, the symmetry axis of the opening area HH coincides with the symmetry axis of the body wiring L1.

In another example, referring to FIG. 23, the NFC coil LL includes one body wiring L1; and the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is rectangular and is located in the notch surrounded by the body wiring L1. In the embodiment, at least part of the edge of the opening area HH is flush with the edge of the body wiring L1 (the orthographic projections thereof on the display module PNL are coincided). Further, the symmetry axis of the opening area HH coincides with the symmetry axis of the body wiring L1.

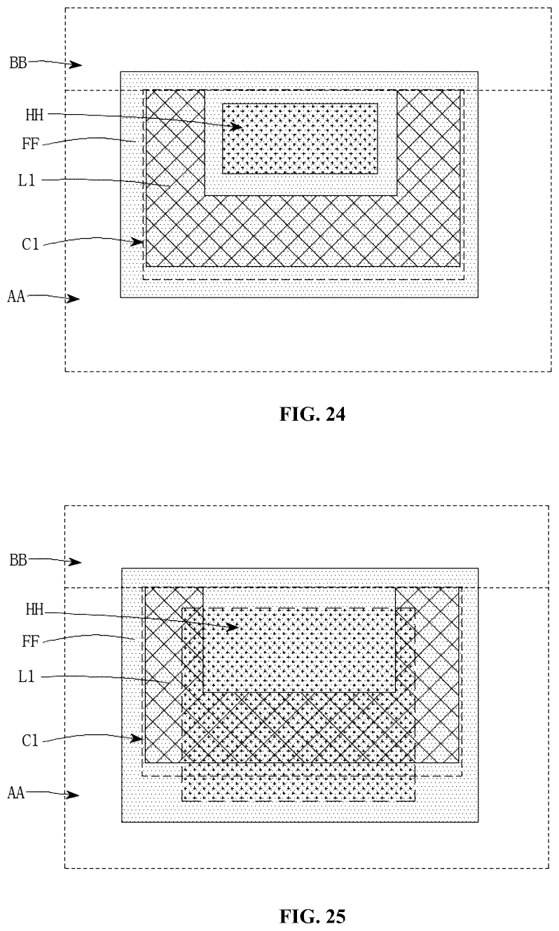

In another example, referring to FIG. 24, the NFC coil LL includes one body wiring L1; and the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is rectangular and is completely located in the notch surrounded by the body wiring L1. There is a gap between the orthographic projection of the opening area HH on the display module PNL and the edge of the body wiring L1. Further, the symmetry axis of the opening area HH coincides with the symmetry axis of the body wiring L1. Further, the geometric center of the opening area HH coincides with the geometric center of the notch surrounded by the body wiring L1.

In another example, referring to FIG. 25, the NFC coil LL includes one body wiring L1; and the body wiring L1 is U-shaped. The ferrite layer FF is rectangular, and the orthographic projection of the ferrite layer FF on the display module PNL covers the respective body wiring L1, for example, it completely covers the NFC first wiring area C1 and covers at least part of the NFC second wiring area C2. The opening area HH is rectangular. The opening area HH covers part of the body wiring L1, covers at least part of the notch surrounded by the body wiring L1, and at least partially extends out of the NFC wiring area CC. Further, the symmetry axis of the opening area HH coincides with the symmetry axis of the body wiring L1.

Other embodiments of the disclosure will be readily apparent to those skilled in the art from consideration of the specification and practice of the invention disclosed herein. This application is intended to cover any variations, uses, or adaptations of the disclosure that follow the general principles of the disclosure and include common knowledge or customary technical means in the technical field that are not disclosed in the disclosure. It is intended that the specification and examples be considered as exemplary only, with a true scope and spirit of the disclosure being indicated by the following claims.

1. A display device, comprising: a back casing, a backlight module and a display module that are stacked in sequence; the display device has an NFC wiring area for disposing an NFC coil; and the NFC coil is disposed in the display module.

2. The display device according to claim 1, wherein a rear casing of the backlight module is made of metal material; the rear casing of the backlight module has an opening area overlapped with the NFC wiring area; and the rear casing of the backlight module is provided with an opening in the opening area.

3. The display device according to claim 2, wherein the rear casing of the backlight module is provided with one opening in the opening NPC wiring area; and an edge of the opening is coincided with an edge of the opening area.

4. The display device according to claim 2, wherein the rear casing of the backlight module is provided with a plurality of openings in the NFC wiring area.

5. The display device according to claim 2, wherein the NFC coil comprises a body wiring disposed in a display area; and
the body wiring is arranged axially symmetrically; and the opening area is arranged symmetrically with respect to a symmetry axis of the body wiring.

6. The display device according to claim 2, wherein the NFC wiring area comprises an NFC first wiring area disposed in a display area and an NFC second wiring area disposed in a peripheral area; and
at least part of the NFC first wiring area is covered by the opening area.

7. The display device according to claim 2, wherein the NFC wiring area comprises an NFC first wiring area disposed in a display area and an NFC second wiring area disposed in a peripheral area; and
a geometric center of the opening area is coincided with a geometric center of the NFC first wiring area.

8. The display device according to claim 1, wherein the back casing is made of metal material; and the display device is provided with a ferrite layer between the back casing and the rear casing of the backlight module.

9. The display device according to claim 8, wherein the ferrite layer is disposed on a surface of the rear casing of the backlight module away from the display module.

10. The display device according to claim 8, wherein an orthographic projection of the ferrite layer on the display module is overlapped with the NFC wiring area.

11. The display device according to claim 8, wherein the NFC wiring area comprises an NFC first wiring area disposed in a display area and an NFC second wiring area disposed in a peripheral area; and
at least part of the NFC first wiring area is covered by the ferrite layer.

12. The display device according to claim 8, wherein the NFC coil comprises a body wiring disposed in a display area; and
the body wiring is covered by the ferrite layer.

13. The display device according to claim 8, wherein the NFC coil comprises a body wiring disposed in a display area; and
the body wiring is arranged axially symmetrically; and the ferrite layer is arranged symmetrically with respect to a symmetry axis of the body wiring.

14. The display device according to claim 2, wherein the back casing is made of metal material; and the display device is provided with a ferrite layer between the back casing and the rear casing of the backlight module; and
at least part of the open area is covered by the ferrite layer.

15. The display device according to claim 14, wherein the opening area is covered by the ferrite layer.

16. The display device according to claim 2, wherein the back casing is made of non-metallic material.

17. The display device according to claim 1, wherein at least a part area of the back casing overlapped with the NFC wiring area is made of non-metallic material; and at least a part area of the rear casing of the backlight module overlapped with the NFC wiring area is made of non-metallic material.

18. The display device according to claim 17, wherein both the back casing and the rear casing of the backlight module are made of non-metallic materials.

19. An electronic equipment, comprising a display device, wherein the display device comprises:
a back casing, a backlight module and a display module that are stacked in sequence; the display device has an NFC wiring area for disposing an NFC coil; and the NFC coil is disposed in the display module.

20. The electronic equipment according to claim 19, wherein a rear casing of the backlight module is made of metal material; the rear casing of the backlight module has an opening area overlapped with the NFC wiring area; and the rear casing of the backlight module is provided with an opening in the opening area.
